(19) United States
(12) Patent Application Publication
(10) Pub. No.: US 2007/0150684 A1
(43) Pub. Date: Jun. 28, 2007

(54) Apparatus for transmitting data via the I2C bus, method of transmitting data via the I2C bus, and program for transmitting data via the I2C bus

(75) Inventor: Yuichi Sakagami, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/376,181

(22) Filed: Mar. 16, 2006

(30) Foreign Application Priority Data
Dec. 22, 2005 (JP) 2005-370317

(51) Int. Cl. G06F 13/28; G06F 12/00

(52) U.S. Cl. 711/165

(57) ABSTRACT

An apparatus and the like for transmitting data via an I2C bus, which is simple in structure and can yet accumulate data transmitted via the I2C bus, thereby to analyze errors in the I2C bus easily. The apparatus comprises a memory circuit 4 connected to the I2C bus that connects a master 1 and a slave 2. The initial I2C address of the memory circuit 4 is set to the same I2C address as that of the slave 2 in order to write data into the slave 2. The data to be written into the slave 2 is saved in the memory circuit 4, and the I2C address of the memory circuit is set back to the initial I2C address after the data has been written into the slave 2. Thus, the data can be stored in the memory circuit before it is written into the slave and can be read from the memory circuit without influencing the operation of reading data from the slave.

### BACKGROUND OF THE INVENTION

1. Field of the Invention

The present invention relates to an apparatus for transmitting data via an I2C bus, which can readily perform error analysis or the like of the I2C bus, a method of transmitting data via the I2C bus, and a program for transmitting data via the I2C bus.

2. Description of the Related Art

Hitherto a measuring device necessary for analyzing errors, such as a synchroscope, is incorporated as tracer and used to reproduce the event, for the purpose of analyzing errors in the I2C bus.

A bus tracer is known, which samples signals related to bus-accessing and stores the sampled data into a memory provided for tracing. (See, for example, Jpn. Pat. Appln. Laid-Open Publication No. 8-314764)

In the conventional technique described above, a measuring device is first incorporated and the event is then reproduced in order to analyze errors in the I2C bus. This technique is cumbersome and requires much time and labor. The technique disclosed in Jpn. Pat. Appln. Laid-Open Publication No. 8-314764 is too complex to apply to extremely simple buses such as the I2C bus. In addition, the technique uses a complicated device, which inevitably raises the cost of analysis.

### SUMMARY OF THE INVENTION

The present invention has been made to solve the problems described above. An object of the invention is to provide an apparatus for transmitting data via an I2C bus, which is simple in structure and can yet accumulate data transmitted via the I2C bus, thereby to analyze errors in the I2C bus easily. Another object of the invention is to provide a method of transmitting data via the I2C bus and a program for transmitting data via the I2C bus.

To achieve the objects described above, an apparatus for transmitting data via an I2C bus that connects a master and a slave, according to the present invention, comprises: a memory circuit that is connected to the I2C bus; and a memory-circuit control unit that sets an initial I2C address of the memory circuit to the same I2C address as that of the slave in order to write data into the slave, then saves, in the memory circuit, the data to be written into the slave, and sets the I2C address of the memory circuit back to the initial I2C address after the data has been written into the slave. Hence, the data can be stored in the memory circuit before it is written into the slave, and the data can be read from the memory circuit without influencing the operation of reading data from the slave.

The apparatus may be designed for use in the case where a plurality of slaves are provided. In this case, when data is written into any of the slaves, the memory-circuit control unit controls the I2C address of the memory circuit in different ways for the slaves, respectively.

This invention provides a method of transmitting data via an I2C bus that connects a master and a slave, which comprises: connecting a memory circuit to the I2C bus; setting an initial I2C address of the memory circuit to the same I2C address as that of the slave in order to write data into the slave; saving, in the memory circuit, the data to be written into the slave; and setting the I2C address of the memory circuit back to the initial I2C address after the data has been written into the slave.

The method may be designed for use in the case where a plurality of slaves are provided. In this case, when data is written into any of the slaves, the I2C address of the memory circuit is controlled in different ways for the slaves, respectively.

This invention provides a program for transmitting data via an I2C bus that connects a master and a slave. The program is designed to cause a computer to perform: a step that sets an initial I2C address of the memory circuit that is connected to the I2C bus to the same I2C address as that of the slave in order to write data into the slave; a step that saves, in the memory circuit, the data to be written into the slave; and a step that sets the I2C address of the memory circuit back to the initial I2C address after the data has been written into the slave.

According to the present invention, it is possible to accumulate data transmitted via the I2C bus with an extremely simple structure, and to perform error analysis of the I2C bus easily.

### BRIEF DESCRIPTION OF THE DRAWINGS

FIG. 1 is a block diagram showing how Embodiment 1 of the invention operates in the idling mode;

FIG. 2 is a block diagram showing how Embodiment 1 of the invention operates in the data-writing mode;

FIG. 3 is a flowchart explaining how Embodiment 1 operates;

FIG. 4 is a block diagram illustrating how Embodiment 2 of the invention operates in the idling mod (and in the data-reading mode); and

FIG. 5 is a block diagram showing how Embodiment 2 of the invention operates in the data-writing mode.

### DETAILED DESCRIPTION OF THE PREFERRED EMBODIMENTS

Embodiments of the present invention will be described, with reference to the accompanying drawings.

### Embodiment 1

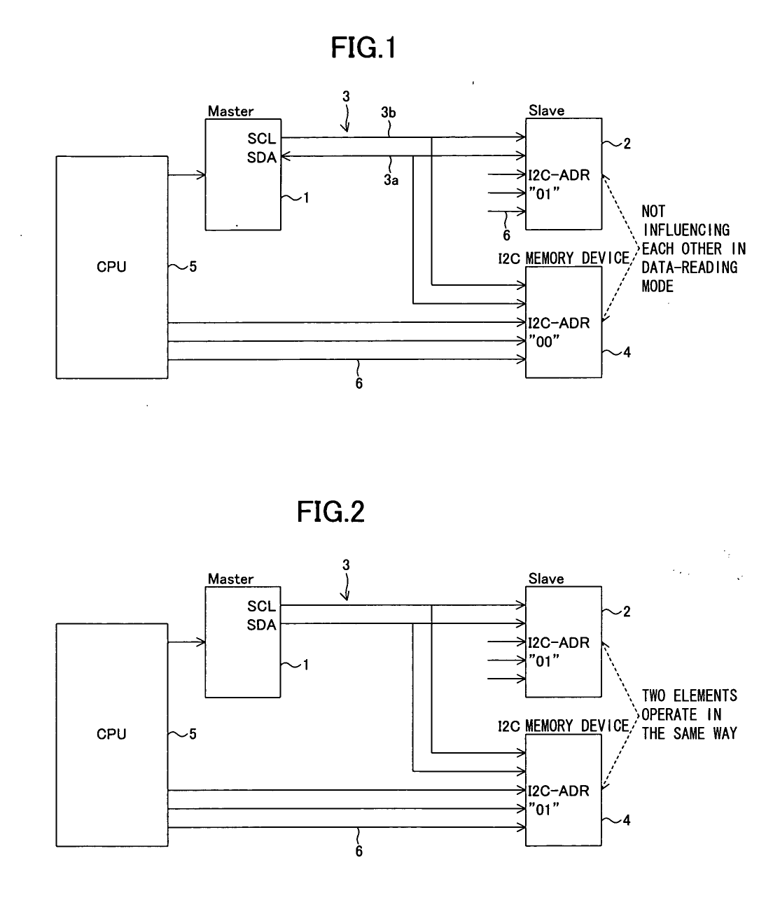

FIGS. 1 and 2 are block diagrams illustrating Embodiment 1 of this invention. As these figures show, a master 1 configured by, e.g., an integrated circuit and a slave 2 having a data storage section are connected by an I2C bus 3. A memory circuit 4 is connected to the I2C bus 3. Firmware controls the I2C address of the memory circuit 4. The firmware operates on a CPU 5 of the present invention. The memory circuit 4 is constituted by a simple memory device (e.g., a nonvolatile memory).

The I2C bus 3 has a data-transmitting line 3a and a clock-transmitting line 3b. Address lines 6 extending from the CPU 5 are connected to the memory circuit 4 and the slave 2.

The firmware switches the I2C address of the memory circuit (i.e., I2C-memory device) 4 to the same I2C address as that of the device (i.e., slave) only when data should be written into the device. Note that the I2C address has been provided by external PIN setting.

The memory circuit 4 gives no acknowledge responses to the data-writing operation. The initial value for the I2C address is set to a specific I2C address that differs from the I2C address of any slave. The memory circuit 4 stores only the data that has been rewritten in accordance with the write command transmitted via the I2C bus 3. When an error occurs in the I2C bus 3, in an error analysis, the value stored in the memory circuit 4 is read and compared with the expected value. It is thereby determined whether the I2C command has been correctly transmitted or not. This makes it easy to distinguish an event from a cause.

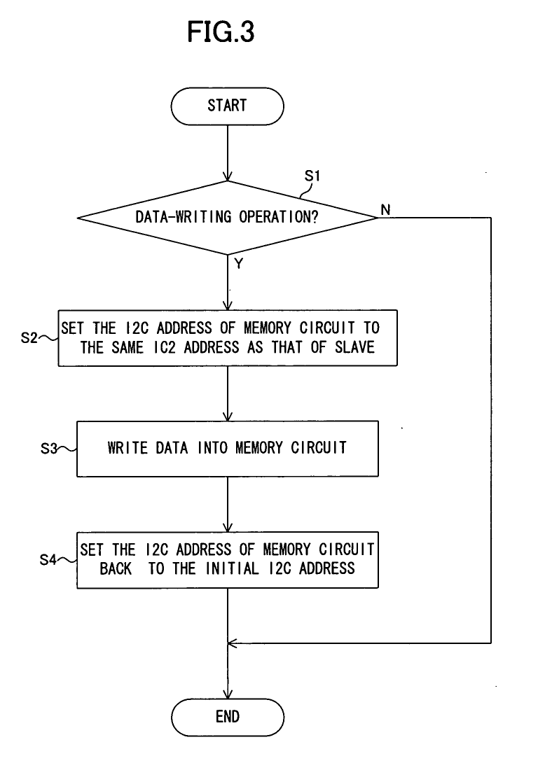

How data is written into the memory circuit 4 in this invention will be described, with reference to the flowchart of FIG. 3. In Embodiment 1, the CPU 5 writes data into the memory circuit 4.

First, it is determined whether the operation is a data-writing operation or not (Step S1). If Yes in Step S1, the firmware switches the I2C address of the memory circuit 4 to the same I2C address as that of the slave 2 (Step S2).

Thus, when data is written into the slave 2, the same data is written into the memory circuit 4, too, and is accumulated therein (Step S3). At this time, the memory circuit 4 makes no acknowledge response.

When the data-writing operation is completed, the firmware sets the I2C address of the memory circuit 4 back to the initial value (Step S4).

If the operation is a data-reading operation (if No in Step S1), the firmware does nothing at all. In this case, the IC2 address of the memory circuit 4 remains different from that of the slave 2. (For example, it is “00” that is different from the IC2 address (e.g., “011”) of the slave 2.)

Hence, the operation of reading data from one device does not influence the operation of reading data from the other device, or vice versa. In other words, the devices do not interfere with each other.

In the configuration described above, when a trouble develops in the I2C bus 3, the data stored in the memory circuit 4 can be read and used to analyze the error in the I2C bus 3. Therefore, the data transmitted via the I2C bus 3 can be accumulated and errors in the I2C bus 3 can be analyzed easily, though Embodiment 1 has a very simple structure.

### Embodiment 2

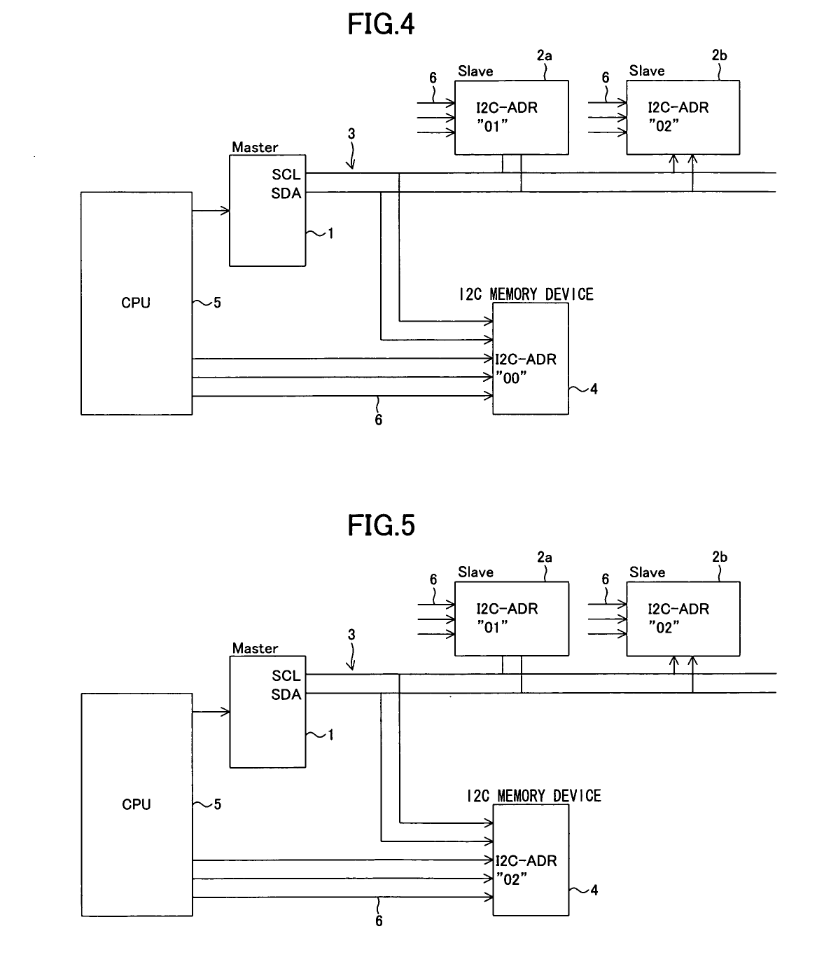

FIGS. 4 and 5 are block diagrams illustrating Embodiment 2 of this invention. They correspond to FIG. 1 and FIG. 2, respectively.

Embodiment 2 differs from Embodiment 1 in that it has two slaves 2a and 2b connected to the I2C bus 3. One memory circuit 4 is connected to the I2C bus as in Embodiment 1.

In Embodiment 2, too, the I2C address of the memory circuit 4 is switched to the same I2C address (e.g., “02”) as that of, for example, the slave 2b if the operation is a data-writing operation. In the idling mode (and in the data-reading mode), the I2C address of the memory circuit 4 is set to one (e.g., “00”) that is different from those of the slaves 2a and 2b.

Each embodiment described above is constituted by firmware that operates on a CPU. Instead, the firmware may be provided in the master.

The firmware constitutes a program for transmitting data via the I2C bus. This program is recorded in a computer-readable recording medium. The recording medium may be a portable storage device such as a CD-ROM, a flexible disk, a DVD, a magneto-optical disk or an IC card, a database storing computer programs, or another computer and a database installed in the other computer, or a transmission medium provided on lines.

What is claimed is:

1. An apparatus for transmitting data via an I2C bus that connects a master and a slave, comprising:
a memory circuit that is connected to the I2C bus; and
a memory-circuit control unit that sets an initial I2C address of the memory circuit to the same I2C address as that of the slave in order to write data into the slave, then saves, in the memory circuit, the data to be written into the slave, and sets the I2C address of the memory circuit back to the initial I2C address after the data has been written into the slave.

2. The apparatus according to claim 1, designed for use in the case where a plurality of slaves are provided, wherein the memory-circuit control unit controls the I2C address of the memory circuit in different ways for the slaves, respectively.

3. A method of transmitting data via an I2C bus that connects a master and a slave, comprising:
connecting a memory circuit to the I2C bus;
setting an initial I2C address of the memory circuit to the same I2C address as that of the slave in order to write data into the slave;
saving, in the memory circuit, the data to be written into the slave; and
setting the I2C address of the memory circuit back to the initial I2C address after the data has been written into the slave.

4. The method according to claim 3, designed for use in the case where a plurality of slaves are provided, wherein the I2C address of the memory circuit are controlled in different ways for the slaves, respectively.

5. A program for transmitting data via an I2C bus that connects a master and a slave, designed to cause a computer to perform:
a step that sets an initial I2C address of the memory circuit connected to the I2C bus to the same I2C address as that of the slave in order to write data into the slave;
a step that saves, in the memory circuit, the data to be written into the slave; and
a step that sets the I2C address of the memory circuit back to the initial I2C address after the data has been written into the slave.
